(19) United States
(12) Patent Application Publication
(10) Pub. No.: US 2023/0263176 A1
(43) Pub. Date: Aug. 24, 2023

(54) USING MULTIPLE UV WAVELENGTHS TO IMPROVE THE COLOR AND SAFETY OF HARVESTED APPLES

(71) Applicant: University of Maryland, College Park, College Park, MD (US)

(72) Inventors: Macarena Farcuh, Silver Spring, MD (US); Rohan Tikekar, Silver Spring, MD (US); Joseph H. Sullivan, Brookeville, MD (US); Yixin Cai, College Park, MD (US); Abraham Moses Monteymayor, Washington, DC (US)

(21) Appl. No.: 18/164,325

(22) Filed: Feb. 3, 2023

Related U.S. Application Data
(60) Provisional application No. 63/267,537, filed on Feb. 3, 2022.

(51) Int. Cl. A23B 7/015; A23L 3/28; A23L 19/00

(52) U.S. Cl. CPC A23B 7/015; A23L 3/28; A23L 19/03

(57) ABSTRACT

Provided herein are methods relating to ultraviolet irradiation of apples to improve their color and safety. The methods allow harvesting apples at optimum maturity, without having to delay waiting for color. The methods result in a significant increase in red skin coloration and suppression of L. monocytogenes without impairing fruit quality attributes during commercial storage.

### CROSS-REFERENCE TO RELATED APPLICATION

This application claims priority to provisional application U.S. Ser. No. 63/267,537, filed Feb. 3, 2022, which is hereby incorporated herein by reference in its entirety.

### GOVERNMENT SUPPORT

This invention was made with government support under 20216800834096 awarded by the United States Department of Agriculture, National Institute of Food and Agriculture. The government has certain rights in the invention.

### TECHNICAL FIELD

The present disclosure generally relates to systems and methods for improving the color and reducing pathogens of harvested fruits, including apples.

### BACKGROUND

Apples (Malus domestica Borkh.) are one of the most valuable fruit crops in the US with an annual wholesale value of approximately $4 billion and the second most consumed fruit in the US. More than 6,000 farms with almost 85,000 acres of apples are located in the Mid-Atlantic region, with five states (PA, VA, WV, MD and DE) producing over 900 million pounds of apples. Honeycrisp is the top sales producing variety across the US. Production of Honeycrisp has doubled over the last five years, making it the fourth most-grown variety in the US. Due to the high consumer demand generated by its unique crispy texture, growers get a much higher wholesale price on Honeycrisp than with other varieties. The mid-Atlantic region markets its greatest volume of Honeycrisp at a higher price range as it is one of the first areas to harvest Honeycrisp each season. With the strong market demand and the likelihood of continued market expansion, there is a positive outlook for increased Honeycrisp apple production regionally and nationally. However, Honeycrisp marketability and the continued growth of the wholesale industry across the eastern US, and particularly in the mid-Atlantic, is threatened by the lack of effective strategies for maintaining the required fruit quality and safety. Growers have experienced dramatic losses as a result of poor or marginal development of skin red coloration which does not meet the minimum 50% to 60% red skin color required by the retail sector. Additionally, foodborne disease outbreaks from Listeria monocytogenes in recent years have placed the whole apple industry at constant risk. Therefore, there is a need to develop new practices that can improve the color and safety of apples and allow harvesting fruit at optimum maturity to improve overall fruit quality, storage capacity, and decrease losses.

### SUMMARY

Methods of improving the color and safety of harvested apples comprising exposing the harvested apples to UV-A radiation or UV-B radiation and UV-C radiation are provided. Methods for promoting postharvest skin coloration of apples are also provided.

The methods of the disclosure allow harvesting apples at optimum maturity, without having to delay waiting for color. The methods result in a significant increase in red skin coloration and suppression of foodborne pathogens such as L. monocytogenes without impairing fruit quality attributes during commercial storage.

While multiple embodiments are disclosed, still other embodiments of the present disclosure will become apparent based on the detailed description, which shows and describes illustrative embodiments of the disclosure. Accordingly, the figures and detailed description are to be regarded as illustrative in nature and not restrictive.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1A-B shows the effect of postharvest UV irradiation on red skin coloration of Honeycrisp apples. FIG. 1A shows the effect of postharvest UV irradiation on apples stored at 20° C. FIG. 1B shows the effect of postharvest UV irradiation on apples stored at 4° C. until day 9 and then transferred to 20° C. (indicated by arrow). Values are means±SE (n=3). Different letters indicate significant differences between evaluation periods within each treatment (P:S0.05) according to Tukey's test. Variation in the values of color parameters on day 0 are due to initial fruit variability.

FIG. 2A-B shows photographs of the effect of postharvest UV-A irradiation on red skin coloration of Honeycrisp apples at different temperatures. FIG. 2A shows the effect of 1800 kJ m⁻² or 2400 kJ m⁻² UV-A at 5° C. FIG. 2B shows the effect of 1800 kJ m⁻² or 2400 kJ m⁻² UV-A at 10° C.

### DETAILED DESCRIPTION

Unless defined otherwise, all technical and scientific terms used herein have the same meaning as commonly understood by one skilled in the art to which embodiments of the disclosure pertain. Many methods and materials similar, modified, or equivalent to those described herein can be used in the practice of the embodiments of the present disclosure without undue experimentation, the preferred materials and methods are described herein.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicates otherwise. The word “or” means any one member of a particular list and also includes any combination of members of that list. Further, all units, prefixes, and symbols may be denoted in their SI accepted form.

Numeric ranges recited within the specification are inclusive of the numbers defining the range and include each integer within the defined range. Throughout this disclosure, various aspects are presented in a range format. It should be understood that the description in range format is merely for convenience and brevity and should not be construed as an inflexible limitation on the scope of the present disclosure or the associated claims. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

Currently the common practice used to increase Honeycrisp red skin color relies on delaying harvest until the minimum 50% to 60% color requirement is met; thus fruit is not harvested at its optimum harvest maturity but at an overripe stage. This practice harms overall fruit quality and storability, as overripe apples soften faster, abscise from the tree before harvest, have higher incidence of developing physiological disorders and thus lower marketability. Fruit maturity at harvest is a critical factor affecting the incidence of physiological disorders such as bitter pit and chilling injury in apples. Delaying the harvest leads to higher fruit spoilage, fruit loss, and less profitability for growers.

UV radiation has emerged as a promising technology for maintaining fresh produce quality and safety during postharvest storage. Efficiency of UV irradiation can be affected by several factors including wavelength, time and intensity of irradiation, nature of the surface subjected to irradiation, fruit type, cultivar sensitivity, fruit previous conditions and treatments, and developmental stage of the fruit. While studies have determined effects of single UV radiation treatments (either UV-B or UV-C), little information has been previously reported on the application of combined UV treatments (e.g., UV-A and UV-C or UV-B and UV-C) during postharvest storage. Postharvest UV-C irradiation has been shown to increase red color development and anthocyanin accumulation in strawberries, but it conversely delays color change in pepper. The effect on apple red skin coloration was previously unknown. Applicants have surprisingly found that the combined UV treatments result in a significant increase in red skin coloration and suppression of foodborne pathogens such as L. monocytogenes.

By better understanding the effects of combined UV irradiation treatments under postharvest storage temperatures of specific apple varieties, these treatments can be optimized to promote red coloration in skin, improving fruit quality and health-related properties as well as suppressing L. monocytogenes. Hence, increasing apple marketability and economic profitability.

Application of UV irradiation treatment during postharvest presents several advantages to the fresh apple industry as the technology is easy to use, does not leave a residue, is approved for microbial reduction in food, does not require expensive equipment, and does not require subsequent removal of moisture.

Methods of improving the color and/or safety of a harvested apple are provided. The methods comprise exposing the harvested apple to ultraviolet (UV) radiation. UV radiation includes long-wave UV-A radiation (320-400 nm), medium-wave UV-B radiation (280-320 nm), and short-wave UV-C radiation (200-280 nm). In certain embodiments, the methods comprise exposing the harvested apple to UV-A radiation and/or UV-B radiation. In certain embodiments, the methods further comprise exposing the harvested apple to UV-C radiation. In these embodiments, the exposure to UV-C radiation can be prior to, concurrent with, or subsequent to the UV-A and/or UV-B exposure. In certain embodiments, the methods comprise exposing the harvested apple to UV-A radiation and UV-C radiation. In certain embodiments, the methods comprise exposing the harvested apple to UV-B radiation and UV-C radiation.

Various dosages of UV-A radiation are contemplated herein. In certain embodiments, the dosage of UV-A radiation is about 100 kJ m⁻² to about 5000 kJ m⁻², about 500 kJ m⁻² to about 3000 kJ m⁻², or about 1000 kJ m⁻² to about 2500 kJ m⁻², including all ranges and subranges therebetween. In certain embodiments, the dosage of UV-A radiation is at least about 100 kJ m⁻², at least about 500 kJ m⁻², at least about 600 kJ m⁻², at least about 700 kJ m⁻², at least about 800 kJ m⁻², at least about 900 kJ m⁻², at least about 1000 kJ m⁻², at least about 1100 kJ m⁻², at least about 1200 kJ m⁻², at least about 1300 kJ m⁻², at least about 1400 kJ m⁻², at least about 1500 kJ m⁻², at least about 1600 kJ m⁻², at least about 1700 kJ m⁻², at least about 1800 kJ m⁻², at least about 1900 kJ m⁻², at least about 2000 kJ m⁻², at least about 2100 kJ m⁻², at least about 2200 kJ m⁻², at least about 2300 kJ m⁻², at least about 2400 kJ m⁻², at least about 2500 kJ m⁻², or at least about 3000 kJ m⁻². In certain embodiments, the dosage of UV-A radiation is about 600 kJ m⁻², about 800 kJ m⁻², about 1200 kJ m⁻², or about 2400 kJ m⁻².

Various dosages of UV-B radiation are contemplated herein. In certain embodiments, the dosage of UV-B radiation is about 10 kJ m⁻² to about 2000 kJ m⁻², about 100 kJ m⁻² to about 1500 kJ m⁻², or about 500 kJ m⁻² to about 1000 kJ m⁻², including all ranges and subranges therebetween. In certain embodiments, the dosage of UV-B radiation is at least about 10 kJ m⁻², at least about 50 kJ m⁻², at least about 100 kJ m⁻², at least about 200 kJ m⁻², at least about 300 kJ m⁻², at least about 400 kJ m⁻², at least about 500 kJ m⁻², at least about 600 kJ m⁻², at least about 700 kJ m⁻², at least about 800 kJ m⁻², at least about 900 kJ m⁻², at least about 1000 kJ m⁻², or at least about 1500 kJ m⁻². In certain embodiments, the dosage of UV-B radiation is about 200 kJ m⁻², about 400 kJ m⁻², about 600 kJ m⁻², or about 800 kJ m⁻².

Various dosages of UV-C radiation are contemplated herein. In certain embodiments, the dosage of UV-C radiation is about 0.1 kJ m⁻² to 20 kJ m⁻², 1 kJ m⁻² to 10 kJ m⁻², or 5 kJ m⁻² to 8 kJ m⁻², including all ranges and subranges therebetween. In certain embodiments, the dosage of UV-C radiation is at least about 1 kJ m⁻², at least about 2 kJ m⁻², at least about 3 kJ m⁻², at least about 4 kJ m⁻², at least about 5 kJ m⁻², at least about 6kJ m⁻², at least about 7 kJ m⁻², at least about 8 kJ m⁻², at least about 9 kJ m⁻², or at least about 10 kJ m⁻².

In certain embodiments, the UV-A radiation can have a wavelength of about 320 nm, about 330 nm, about 340 nm, about 350 nm, about 360 nm, about 370 nm, about 380 nm, about 390 nm, or about 400 nm. In certain embodiments, the UV-B radiation can have a wavelength of about 280 nm, about 290 nm, about 300 nm, about 310 nm, about 320 nm. In certain embodiments, the UV-C radiation can have a wavelength of about 200 nm, about 210 nm, about 220 nm, about 230 nm, about 240 nm, about 250 nm, about 260 nm, about 270 nm, or about 280 nm. In certain embodiments, the UV radiation can have a wavelength from about 200 nm to about 220 nm, about 200 nm to about 240 nm, about 200 nm to about 260 nm, about 200 nm to about 280 nm, about 200 nm to about 300 nm, about 200 nm to about 320 nm, about 200 nm to about 340 nm, about 200 nm to about 360 nm, about 200 nm to about 380 nm, about 200 nm to about 400 nm, about 220 nm to about 240 nm, about 220 nm to about 260 nm, about 220 nm to about 280 nm, about 220 nm to about 300 nm, about 220 nm to about 320 nm, about 220 nm to about 340 nm, about 220 nm to about 360 nm, about 220 nm to about 380 nm, about 220 nm to about 400 nm, about 240 nm to about 260 nm, about 240 nm to about 280 nm, about 240 nm to about 300 nm, about 240 nm to about 320 nm, about 240 nm to about 340 nm, about 240 nm to about 360 nm, about 240 nm to about 380 nm, about 240 nm to about 400 nm, about 260 nm to about 280 nm, about 260 nm to about 300 nm, about 260 nm to about 320 nm, about 260 nm to about 340 nm, about 260 nm to about 360 nm, about 260 nm to about 380 nm, about 260 nm to about 400 nm, about 280 nm to about 300 nm, about 280 nm to about 320 nm, about 280 nm to about 340 nm, about 280 nm to about 360 nm, about 280 nm to about 380 nm, about 280 nm to about 400 nm, about 300 nm to about 320 nm, about 300 nm to about 340 nm, about 300 nm to about 360 nm, about 300 nm to about 380 nm, about 300 nm to about 400 nm, about 320 nm to about 340 nm, about 320 nm to about 360 nm, about 320 nm to about 380 nm, about 320 nm to about 400 nm, about 340 nm to about 360 nm, about 340 nm to about 380 nm, about 340 nm to about 400 nm, about 360 nm to about 380 nm, about 360 nm to about 400 nm, or about 380 nm to about 400 nm, including all ranges and subranges therebetween. In certain embodiments, a combination of different wavelengths within the UV-A, UV-B, or UV-C spectrum is concurrently used.

A number of UV exposure durations are consistent with the methods provided herein. In certain embodiments, the UV exposure duration is in a range of about 1 day to about 14 days, about 2 days to about 12 days, about 4 days to about 10 days, or about 6 days to about 8 days, including all ranges and subranges therebetween. In certain embodiments, the length of time of the UV exposure is at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, or at least about 14 days. In certain embodiments, the exposure is for about 7 days. In certain embodiments, the length of time of the UV exposure is up to 72 hours, up to 60 hours, up to 48 hours, up to 36 hours, up to 24 hours, up to 12 hours, or up to 6 hours. In certain embodiments, the UV exposure is at least about 6 hours, at least about 12 hours, at least about 24 hours, at least about 36 hours, at least about 48 hours, at least about 60 hours, or at least about 72 hours.

The UV radiation can be from a variety of sources. Suitable sources of UV radiation include, by way of non-limiting examples, UV lamps, UV fluorescent lamps, UV LEDs, UV lasers, and the like.

Chilling sensitive apple varieties, such as Honeycrisp, can develop physiological disorders, such as chilling injury, when cooled immediately after commercial harvest. The use of a temperature conditioning period at a relatively warm storage temperature (e.g., 10° C.) after commercial harvest for up to seven days, followed by cold storage (e.g., 3° C.) is usually used. In certain embodiments, the harvested apple is exposed to UV radiation during the temperature conditioning period. In certain embodiments, the harvested apple is maintained at a temperature of about 1° C. to about 25° C., about 5° C. to about 20° C., or about 10° C. to about 15° C., including all ranges and subranges therebetween, during the UV exposure. In certain embodiments, the harvested apple is maintained at a temperature of about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., or about 20° C. during the UV exposure.

In certain embodiments, the methods of the disclosure comprise subjecting the harvested apple to cold storage following the UV exposure. In certain embodiments, the harvested apple is stored at a temperature of about 1° C. to about 5° C., about 2° C. to about 4° C., or about 3° C., including all ranges and subranges therebetween. In certain embodiments the apple is stored for about 1 day to about 12 weeks, about 1 week to about 10 weeks, about 2 weeks to about 8 weeks, or about 4 weeks to about 6 weeks, including all ranges and subranges therebetween. In certain embodiments the apple is stored for at least about 1 day, at least about 2 days, at least about 3 days, at least about 4 days, at least about 5 days, at least about 6 days, at least about 1 week, at least about 2 weeks, at least about 3 weeks, at least about 4 weeks, at least about 5 weeks, at least about 6 weeks, at least about 7 weeks, at least about 8 weeks, at least about 9 weeks, at least about 10 weeks, at least about 11 weeks, or at least about 12 weeks.

The methods described herein result in improved color of a harvested apple. The content and composition of anthocyanins, a class of phenolic compounds, mainly determines the intensity and quality of red skin color in apples. Anthocyanin biosynthesis in apple skin is developmentally regulated, and occurs at fruitlet stage and during fruit ripening. Anthocyanin accumulation is also affected by environmental factors such as temperature and light, among others. The ideal conditions for red color development in apples correspond to bright, clear days with temperatures of 25° C. and cool nights (15° C.) during preharvest (2-3 weeks preharvest). Light intensity and wavelength are also key factors affecting red apple color, as most enzymes involved in the anthocyanin biosynthesis pathway are light inducible. As anthocyanin biosynthesis is suppressed at warmer temperatures (hot days >32° C. and warm nights >20° C.), varieties such as Honeycrisp often produce marginal red coloration when grown under hot and humid conditions.

In certain embodiments, the improved color comprises an increase in surface blush percentage. As used herein, “surface blush” refers to the red or pink color on the skin of the fruit. “Surface blush percentage” refers to the percentage of the surface area of the fruit that is covered in red or pink color.

In certain embodiments, the surface blush percentage of the harvested apple prior to performing the methods of the present disclosure is between about 1% to about 60%, about 10% to about 50%, or about 20% to about 40%, including all ranges and subranges therebetween. In certain embodiments, the surface blush percentage is less than about 60%, less than about 50%, less than about 40%, less than about 30%, less than about 20%, or less than about 10% prior to performing the methods of the present disclosure.

In certain embodiments, the surface blush percentage of a harvested apple increases after performing the methods of the present disclosure to between about 40% and about 100%, about 50% to about 90%, or about 60% to about 80%, including all ranges and subranges therebetween. In certain embodiments, the surface blush percentage is increased to at least about 50%, at least about 55%, at least about 60%, at least about 65%, at least about 70%, at least about 75%, at least about 80%, at least about 85%, or at least about 90%.

In certain embodiments, the surface blush percentage of a harvested apple increases after performing the methods of the present disclosure between about 20% and about 80%, about 30% to about 70%, or about 40% to about 60%, including all ranges and subranges therebetween. In certain embodiments, the surface blush percentage increases at least about 20%, at least about 30%, at least about 40%, at least about 50%, at least about 60%, at least about 70%, or at least about 80%.

In certain embodiments, the methods described herein result in improved safety of the harvested apple. Fresh apples can be a vehicle for the transmission of major foodborne pathogens, such as L. monocytogenes. CDC estimates that L. monocytogenes is the third cause of death from foodborne illness in the US, causing approximately 1,600 illnesses annually with a 16% mortality rate. Thus, L. monocytogenes is listed by the U.S. FDA as a “pathogen of concern” in fresh produce due to its nature as an environmental species, frequent occurrence in produce-associated environments and operations, and high mortality rate. The major sources of bacterial contamination of fresh produce are found in the postharvest operations rather than field conditions. Typically, fresh apples for wholesale are cleaned in various ways including washing in the presence of aqueous sanitizers as well as using mechanical force, such as brushing before storage under low temperatures. These practices are not sufficient for suppressing L. monocytogenes from fresh apple surfaces, as it can survive under short-term and long-term storage.

In certain embodiments, the presence of a pathogen on the surface of the harvested apple is reduced or eliminated. In certain embodiments, the pathogen is a foodborne pathogen. Examples of pathogens, the number of which can be reduced by the methods of the disclosure, encompass bacteria, viruses, and fungi. Examples of the bacteria include, but are not limited to, pathogenic Escherichia coli, bacteria belonging to the genus Salmonella (e.g., Salmonella enteritidis), or bacteria belonging to the genus Listeria (e.g., Listeria monocytogenes). In certain embodiments, the pathogen is Listeria monocytogenes.

In certain embodiments, the reduction in pathogen level is at least about 2%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%. In certain embodiments, the reduction in pathogen level is in the range of about 5% to about 100%, about 10% to about 90%, about 20% to about 80%, about 30% to about 70%, about 40% to about 60%, about 50% to about 95%, about 65% to about 85%, or about 75% to about 95%. In certain embodiments, the reduction in pathogen level is by at least about 0.5-fold, at least about 1.0-fold, at least about 1.5-fold, at least about 2.0-fold, at least about 2.5-fold, at least about 3.0-fold, at least about 3.5-fold, at least about 4.0-fold, at least about 5.0-fold, at least about 6.0-fold, at least about 7.0-fold, at least about 8.0-fold, at least about 9.0-fold, at least about 10-fold, or more than 10-fold.

Any variety of apple can be used in the methods of the present disclosure. In certain embodiments, the apple is a red-skinned variety. Suitable varieties of apple include, but are not limited to, Fuji, Honeycrisp, Red Delicious, Gala, McIntosh, Rome, Empire, Idared, Jonathan, York, Cripps Pink, Braeburn, Jazz, Cortland, Northern Spy, Jonagold, Stayman, Ambrosia, and Cameo. In certain embodiments, the apple is a Honeycrisp apple.

The methods of the present disclosure can be performed not only with apples but also with other harvested fruits. Examples of other suitable harvested fruit include, but are not limited to, pear, apricot, olive, almond, cherry, blackberry, blueberry, kiwifruit, nectarine, peach, pomegranate, persimmon, plum, raspberry, citrus, strawberry, tomato, and grape.

The following numbered embodiments also form part of the present disclosure:

1. A method of improving the color and safety of a harvested fruit, the method comprising: exposing the harvested fruit to (i) UV-A radiation or UV-B radiation and (ii) UV-C radiation.

2. The method of embodiment 1, wherein the harvested fruit is maintained at a temperature of about 5° C. to about 20° C. for the duration of the UV exposure.

3. The method of embodiment 1 or embodiment 2, wherein the harvested fruit is maintained at a temperature of about 10° C. for the duration of the UV exposure.

4. The method of any one of embodiments 1-3, wherein the dosage of the UV-A radiation is in a range of about 100 kJ m⁻² to about 5000 kJ m⁻².

5. The method of any one of embodiments 1-4, wherein the dosage of the UV-B radiation is in a range of 10 kJ m⁻² to 2000 kJ m⁻².

6. The method of any one of embodiments 1-5, wherein the dosage of the UV-C radiation is in a range of 1 kJ m⁻² to 10 kJ m⁻².

7. The method of any one of embodiments 1-6, wherein the duration of the exposure is from about 1 day to about 14 days.

8. The method of any one of embodiments 1-7, further comprising storing the fruit at a temperature of about 1° C. to about 5° C.

9. The method of any one of embodiments 1-8, wherein the presence of a pathogen on the surface of the harvested fruit is reduced or eliminated.

10. The method of embodiment 9, wherein the pathogen is Listeria monocytogenes.

11. The method of any one of embodiments 1-10, wherein the fruit is an apple, pear, apricot, olive, almond, cherry, blackberry, blueberry, kiwifruit, nectarine, peach, pomegranate, persimmon, plum, raspberry, citrus, strawberry, tomato, or grape.

12. The method of any one of embodiments 1-11, wherein the fruit is an apple.

13. The method of embodiment 12, wherein the apple is a red-skinned variety.

14. The method of embodiment 12 or embodiment 13, wherein the apple is a Honeycrisp apple.

15. The method of any one of embodiments 12-14, wherein the surface blush percentage of the harvested apple is less than about 50% prior to the exposure.

16. The method of any one of embodiments 12-15, wherein the surface blush percentage of the harvested apple is increased to at least about 60%.

17. A method for promoting postharvest skin coloration of a fruit, the method comprising: exposing a harvested fruit to UV-A radiation or UV-B radiation at a temperature of about 5° C. to about 20° C.

18. The method of embodiment 17, wherein the dosage of the UV-A radiation is in a range of about 100 kJ m⁻² to about 5000 kJ m⁻².

19. The method of embodiment 17 or embodiment 18, wherein the dosage of the UV-B radiation is in a range of 10 kJ m⁻² to 2000 kJ m⁻².

20. The method of any one of embodiments 17-19, wherein the duration of the exposure is from about 1 day to about 14 days.

21. The method of any one of embodiments 17-20, further comprising storing the harvested fruit at a temperature of about 1° C. to about 5° C.

22. The method of any one of embodiments 17-21, wherein the UV radiation further comprises UV-C radiation.

23. The method of embodiment 22, wherein the dosage of the UV-C radiation is in a range of 1 kJ m⁻² to 10 kJ m⁻².

24.The method of any one of embodiments 17-23, wherein the presence of a pathogen on the surface of the harvested fruit is reduced or eliminated.

25.The method of embodiment 24, wherein the pathogen is Listeria monocytogenes.

26. The method of any one of embodiments 17-25, wherein the fruit is an apple, pear, apricot, olive, almond, cherry, blackberry, blueberry, kiwifruit, nectarine, peach, pomegranate, persimmon, plum, raspberry, citrus, strawberry, tomato, or grape.

27. The method of any one of embodiments 17-26, wherein the fruit is an apple.

28. The method of embodiment 27, wherein the apple is a red-skinned variety.

29. The method of embodiment 27 or embodiment 28, wherein the apple is a Honeycrisp apple.

30. The method of any one of embodiments 27-29, wherein the surface blush percentage of the harvested apple is less than about 50% prior to the exposure.

31. The method of any one of embodiments 27-30, wherein the surface blush percentage of the harvested apple is increased to at least about 60%.

Although the foregoing disclosure has been described in some detail by way of illustration and example for purposes of clarity of understanding, it will be obvious that certain changes and modifications may be practiced within the scope of the appended claims.

The following examples are offered by way of illustration and not by way of limitation.

### EXAMPLES

### Example 1

The effect of different postharvest UV treatments, along with a control, on skin color were assessed in Honeycrisp apples. A total of 72 apples were randomly divided into eight groups of nine fruit each. Two groups were submitted to postharvest UV-B irradiation (36 kJ m⁻²), two groups to UV-C (8 kJ m⁻²), two groups to sequential UV-B+UV-C (36 kJ m⁻² UV-B+8 kJ m⁻²UV-C) and two groups were untreated controls. Within each UV treatment, one group was stored at 20° C. for 15 days and the other group was stored at 4° C. for 9 days and then transferred to 20° C. for 6 days. All treatments were conducted at room temperature using benchtop UV incubators (UV intensity measured by built-in radiometer). Dosage was calculated using the equation: UV dose (kJ m⁻²)=Incident intensity (kW m⁻²)×duration of exposure (s).

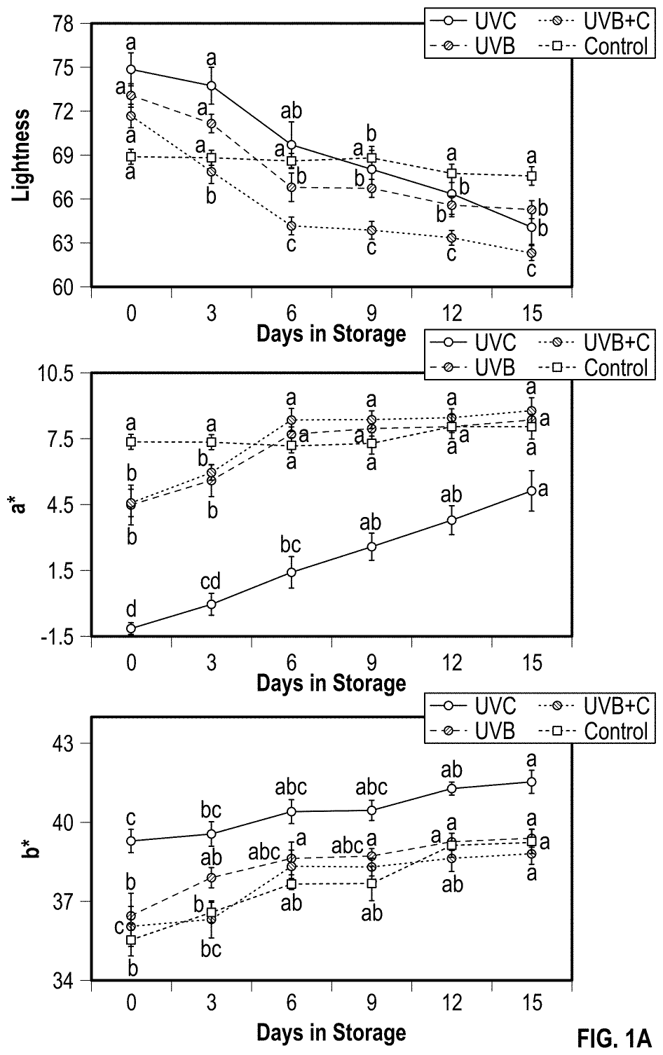

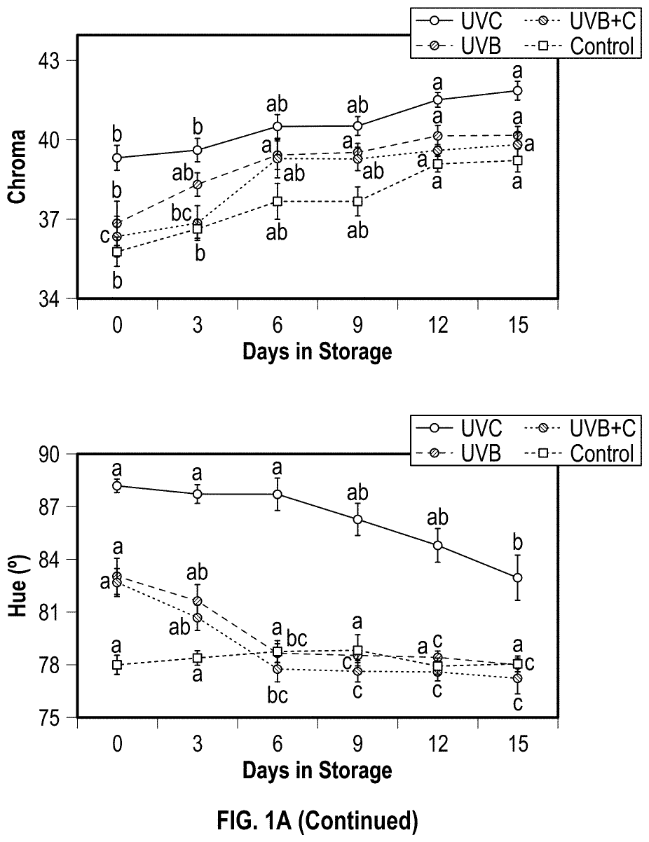

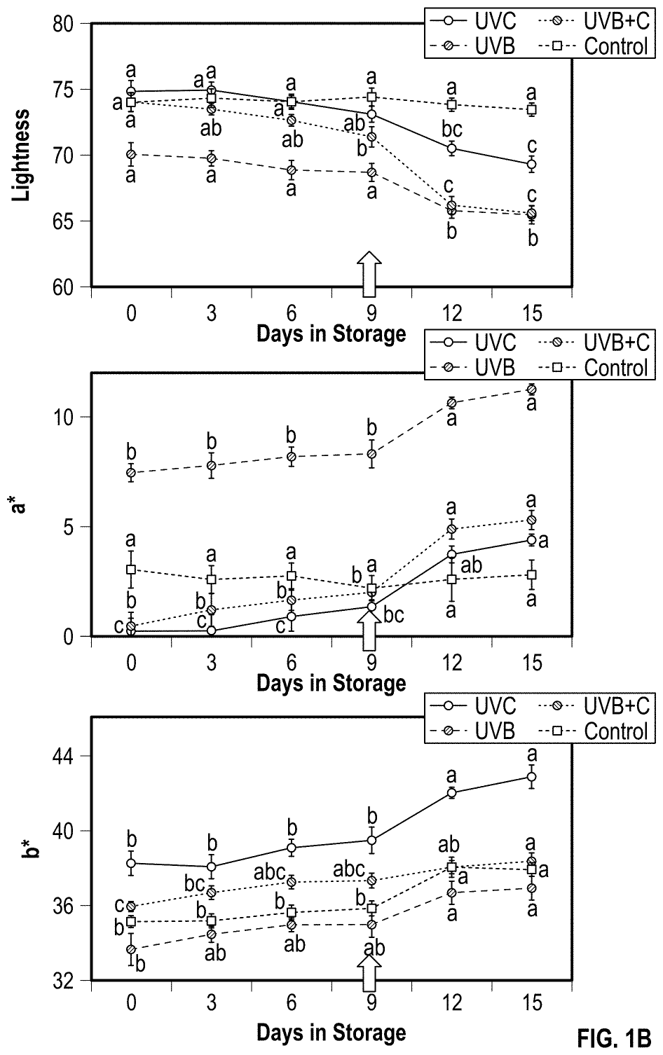

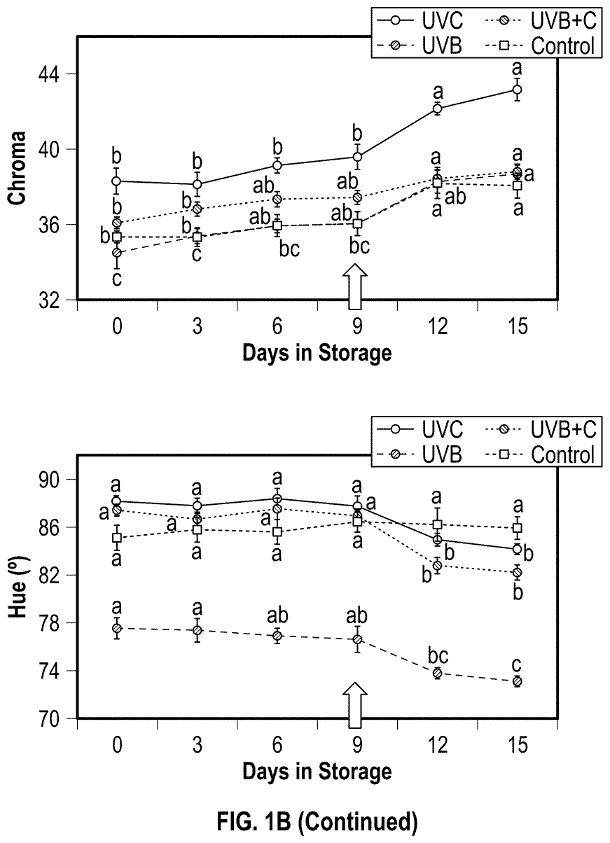

Fruit skin color quantification was evaluated with a hand-held colorimeter and evaluated after 0, 3, 6, 9, 12, and 15 days of storage. CIE L* a* b* color space values, where L measures lightness and varies from 100 for perfect white to zero for black; a* measures redness when positive and greenness when negative; b* measures yellowness when positive and blueness when negative, were recorded. Chroma (C) values, which are an estimate of the saturation of color and Hue (H°) values, which represent changes in primary colors (0°/360°32 red-violet, 45°=orange, 90°=yellow, 180°=green, 270°=blue) were calculated. Assessed exposed areas were delimited by circles to consistently measure the same area. Results were submitted to one-way ANOVA followed by Tukey's multiple means test to compare between evaluation periods within each treatment (P:S0.05). The results showed that all UV treated fruit stored at 20° C. presented a significant decrease in L and H° values and a significant increase in a* values during storage, while control fruit did not change (FIG. 1A). This indicates that all UV treatments induced changes towards a darker and redder skin color trend. Values for b* and C significantly increased during storage for all treatments, including control; indicating that yellow coloration seems not to be affected by UV treatment. There were no significant changes in color parameters during storage at 4° C., while when fruit were transferred to 20° C. (day 9), the same trends as described in FIG. 1A were observed for all treatments (FIG. 1B). These data show that postharvest UV treatments, under commercial storage temperatures, positively impact Honeycrisp skin color related parameters.

### Example 2

The goal of this example was to evaluate and compare the effect of different postharvest UV irradiation treatments, applied under different storage temperatures on Honeycrisp skin red coloration, surface blush percentage, and ethylene production rate.

Honeycrisp apples were harvested at optimal maturity, and submitted to postharvest UV-A (600, 1200, 1600, 2400 kJ m⁻²) alone, UV-B (200, 400, 600, 800 kJ m⁻²) alone, select combinations of UV-A (600 kJ m⁻²) or UV-B (400 kJ m⁻²) followed by UV-C (7.5 kJ m⁻²) irradiation treatments on the unblushed side. UV-C dose was selected based on experiments that demonstrated 1.2 log CFU/sample inactivation of L. monocytogenes, and additional UV-C dose did not result in additional inactivation (see Example 3). Apples were treated during a seven-day conditioning period at either 5° C. or 10° C., and transferred to cold storage at 3° C., along with dark and white light controls. Evaluations were conducted at the end of the conditioning period and biweekly during 3° C. storage for up to twelve weeks.

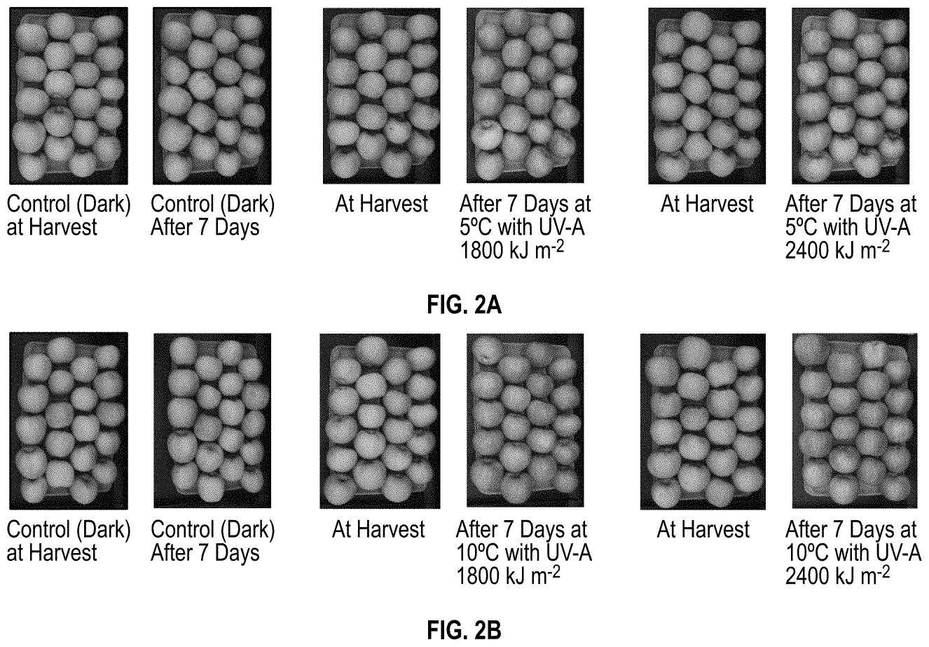

A dose-dependent, dramatic decrease in hue values of the skin, with 2400 kJ m⁻² UV-A and 800 kJ m⁻²UV-B displaying the lowest hue values. The dose dependent increase in red skin coloration observed for UV-A or UV-B correlated with a significantly higher skin red blush percentage area. These red skin coloration differences were higher in fruit treated at 10° C. compared to those treated at 5° C. (FIG. 2A-B). Additional exposure to UV-C following the select UV-A or UV-B treatments did not have impact on fruit quality. No differences were observed in ethylene production rates in fruit submitted to UV treatments, regardless of the wavelength, dose, or conditioning temperature, compared to control fruit.

### Example 3

This example focuses on identifying the UV-C dose needed to achieve L. monocytogenes reduction on the Honeycrisp apple surface.

A batch-UV processing unit (UV-C radiation, model # XL-1000,Spectrolinker UV crosslinker by Spectroline Laboratory) was used for all experiments. The UV chamber contains five UV bulbs (BLE-8T354) emitting UV-C (254 nm) radiation within a 34.3×17.8×19.1 cm inner chamber. UV-C radiation doses were measured by an internal radiometer calibrated and programed by the manufacturer. The processing unit was programmed to shut off after the prescribed dose level was achieved. Variation in incident intensity was minimized using the manufactures recommendation of a five-minute warm-up period from a cold start to allow the UV tubes to stabilize for more accurate operation. An intensity check was also performed to ensure that units were operating at the proper intensity each day.

Honeycrisp apples were harvested at their green stage from a commercial orchard in Maryland, USA. The apples were carefully selected to ensure the absence of scarring or bruising. The apples were then sanitized with 70% ethanol, tween 20 (to remove wax), and rinsed again with deionized water. The apples (whole) were then placed inside a biosafety cabinet with laminar airflow to dry for 120 minutes at the ambient room temperature (approximately 22° C.) to remove any remaining moisture from the apple's surface. Apples were then sliced along the sagittal plane into 6 even wedges using a food-grade stainless steel knife, sterilized with 70% ethanol. A circular impression with a 1-inch diameter was then made on the surface of each wedge using USDA standards for grades area gauge, IA #30 G, sterilized with 70% ethanol. Sterile plastic toothpicks were then inserted into the flesh of each edge in order to allow the wedge to sit upright with the outer surface (skin) of the apple facing directly upward and as level as possible on a sterile petri dish.

Listeria monocytogenes (ATCC #43256) has been used in other studies that involved microbiological responses on the surface of fruits and vegetables and was selected as the pathogen of choice for this example. The L. monocytogenes strain was stored in 30% glycerol (w/w), 20% water (v/v), tryptic soy broth (TSB) in a −80° C. freezer. Frozen L. monocytogenes was sub-cultured in TSB and incubated for 24 hours at 37° C. three consecutive times. After the third sub-culture step, the final strain grown was incubated at 37° C. for 24 hours, allowing the bacteria to reach a stationary phase (approximately 7.8 log CFU/mL). This is the initial inoculum population-level used for the experiment.

The L. monocytogenes inoculum was vortexed for 20 seconds before each inoculation. The 1-inch circle marked on each apple slice was then spot inoculated with a total of 200 μL of the inoculum in a bead-like fashion. The inoculated apples were then allowed to dry in a laminar airflow biosafety cabinet for 120 minutes. Once dry, apple slices were incubated at 4° C. for 24 hours to simulate commercial storage conditions.

Upon completion of the 24-hour incubation period at 4° C., the apples were placed directly in the center of the UV processing unit and exposed to UV-C (254 nm) radiation for a total dose of 0-, 7.5-, 15- and 30-kJ m⁻². Each treatment dose was measured by the internal radiometer calibrated and programed by the manufacturer. Once the internal radiometer has reached the dose programmed into the system, the UV processing unit automatically shuts off.

Immediately after each treatment, the 1-inch marked surface area previously inoculated with L. monocytogenes was carefully cut away from the apple flesh using a sterile stainless steel disposable scalpel. The inoculated apple discs were then transferred into a sterile stomacher bag containing 5 mL of 0.1% buffered peptone water (BPW). Samples were hand massaged for 2 minutes and stomached at the high-speed setting for 5 minutes. The supernatant collected after stomaching was then serial diluted to 0-, 10-, and 100× for each sample. 50 μL of each sample was then spiral plated on Tryptic Soy Agar (TSA) plates using a spiral plater. The plates were then incubated at 37° C. for 24 hours, and the colonies were counted using a colony counter.

All experiments were performed in triplicate. A statistical t-test (α32 0.05, p21 0.05) was used to determine significant differences in UV-C treatments on the inoculated surface of the Honeycrisp apple.

The initial population of L. monocytogenes used to inoculate the surface of each apple was approximately 7.8 log CFU/mL. However, after surface inoculation, drying for 120 minutes at an ambient temperature of 22° C., and a 24-hour incubation at 4° C., the average population on the apple surface before treatment (control) was measured to be 4.2±0.03 log/CFU sample. This initial reduction in the population of L. monocytogenes could be attributed to the stress of the ambient air drying and the 4° C. incubation period.

The average reduction of each individual UV-C treatment resulted in a 1.1±0.3 log CFU/sample inactivation of L. monocytogenes on the apple surface. The UV-C dose of 7.5 kJ m⁻² was the minimum dosage needed to achieve a 1.2±0.06 log CFU/sample inactivation of L. monocytogenes on the apple surface, and the additional UV-C dose did not result in additional inactivation.

What is claimed is:

1. A method of improving the color and safety of a harvested apple, the method comprising:
exposing the harvested apple to (i) UV-A radiation or UV-B radiation and (ii) UV-C radiation.

2. The method of claim 1, wherein the harvested apple is maintained at a temperature of about 5° C. to about 20° C. for the duration of the UV exposure.

3. The method of claim 2, wherein the harvested apple is maintained at a temperature of about 10° C. for the duration of the UV exposure.

4. The method of claim 1, wherein the dosage of the UV-A radiation is in a range of about 100 kJ m⁻² to about 5000kJ m⁻².

5. The method of claim 1, wherein the dosage of the UV-B radiation is in a range of 10 kJ m⁻² to 2000 kJ m⁻².

6. The method of claim 1, wherein the dosage of the UV-C radiation is in a range of 1 kJ m⁻² to 10 kJ m⁻².

7. The method of claim 1, wherein the duration of the exposure is from about 1 day to about 14 days.

8. The method of claim 1, further comprising storing the apple at a temperature of about 1° C. to about 5° C.

9. The method of claim 1, wherein the presence of a pathogen on the surface of the harvested apple is reduced or eliminated.

10. The method of claim 9, wherein the pathogen is Listeria monocytogenes.

11. The method of claim 1, wherein the apple is a red-skinned variety.

12. The method of claim 1, wherein the apple is a Honeycrisp apple.

13. The method of claim 1, wherein the surface blush percentage of the harvested apple is less than about 50% prior to the exposure.

14. The method of claim 1, wherein the surface blush percentage of the harvested apple is increased to at least about 60%.

15. A method for promoting postharvest skin coloration of an apple, the method comprising:
exposing a harvested apple to UV-A radiation or UV-B radiation at a temperature of about 5° C. to about 20° C.

16. The method of claim 15, wherein the dosage of the UV-A radiation is in a range of about 100kJ m⁻² to about 5000 kJ m⁻².

17. The method of claim 15, wherein the dosage of the UV-B radiation is in a range of 10 kJ m⁻² to 2000 kJ m⁻².

18. The method of claim 15, wherein the duration of the exposure is from about 1 day to about 14 days.

19. The method of claim 15, further comprising storing the harvested apple at a temperature of about 1° C. to about 5° C.

20. The method of claim 15, wherein the apple is a Honeycrisp apple.
